(19) United States
(12) Patent Application Publication
(10) Pub. No.: US 2004/0232398 A1
(43) Pub. Date: Nov. 25, 2004

(54) Cable winch arrangement and method for the operation thereof

(76) Inventors: Hubert Mert, Schrobenhausen (DE); Lothar Herbert Schirmel, Lippertshofen (DE)

Correspondence Address: JACOBSON HOLMAN PLLC, 400 SEVENTH STREET N.W., SUITE 600, WASHINGTON, DC, 20004, US

(21) Appl. No.: 10/838,301

(22) Filed: May 5, 2004

(30) Foreign Application Priority Data
May 9, 2003 (DE) 103 20 946.8

(51) Int. Cl. B66D 1/10

(52) U.S. Cl. 254/360

(57) ABSTRACT

The invention relates to a cable winch arrangement with a cable winch, a winch drive and a control device, as well as to a method for the operation thereof. The control device makes it possible to connect in a first operating mode for raising and lowering and a second operating mode in which it is possible to set a superimposed load on a cable of the winch.

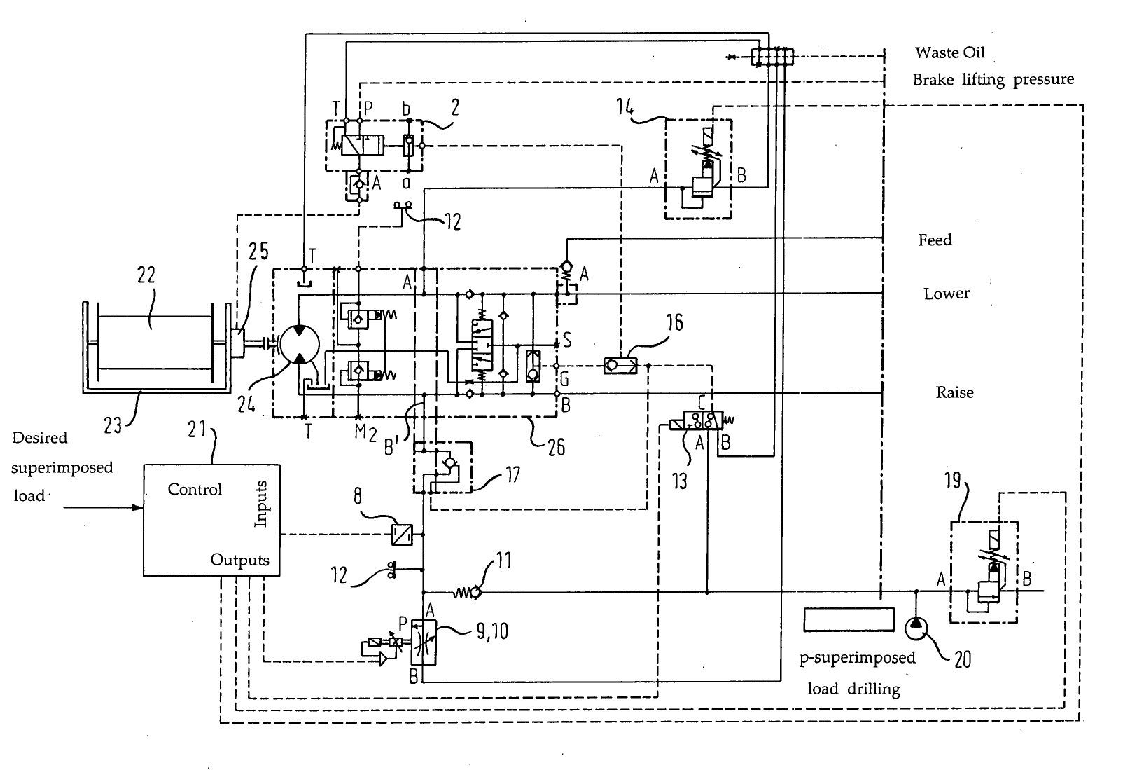

The invention relates to on the one hand a cable winch arrangement with a cable winch, a winch drive and a control device and on the other to a method for the operation thereof.

Such cable winch arrangements are more particularly used in special underground construction engineering. Such winches are e.g. used for raising and lowering so-called pile drilling tools with which it is possible to drill holes or bores with a drilling depth of approximately 100 m and diameters drilled of approximately 1 to 3 m. As a result of the large diameter drilled, in the case of pile drilling the total weight of the drilling line and possibly an additional contact pressure is used as the superimposed load for the drilling tool.

So-called well boring or drilling differs from pile drilling and the necessary well drilling equipment have a much smaller diameter drilled of approximately max. 300 mm to 500 mm. However, the drilling depths needed range from several 100 m to approximately 1000 m. As a result of the small diameter drilled and the greater drilling depths, the superimposed load on the drill head produced by the drilling line weight would be excessive, so that damage thereto could arise. To prevent this the superimposed load must be reduced in precisely controlled manner by means of the winch carrying the drilling line. Such a superimposed load control procedure is normally brought about by using special winches having two drive motors, such as is e.g. known from DE 41 34 742 C1.

The object of the invention is to provide a cable winch arrangement and a method for the operation thereof with which it is possible in the case of a simple construction to bring about a reliable superimposed load control.

According to the invention this object is achieved by a cable winch arrangement having the features of claim 1 and by a method for the operation of a cable winch arrangement according to the features of claim 6. Preferred embodiments of the invention are given in the dependent claims.

The cable winch arrangement according to the invention is characterized in that through the control device it is possible to connect in a first operating mode for raising and lowering and a second operating mode in which a superimposed load can be adjusted on a cable winch.

A fundamental idea of the invention is to provide a control with two operating modes. The control is constructed with a first operating mode designed for normal raising and lowering operation. During such operation and without a complicated control, it is possible for a rapid, efficient raising and lowering to take place, such as is e.g. adequate for pile drilling. However, according to the invention the control can also be switched to a second operating mode in which, by means of an input possibility of the control, it is possible to set a desired, reduced superimposed load and the control device by means of corresponding control members correspondingly controls and monitors the winch drive. The control can also incorporate regulation of the winch drive. The cable winch arrangement design according to the invention in this way also permits use for well drilling without two drives having to be provided, as is the case in the prior art.

According to a preferred embodiment of the invention, the winch drive has a hydraulic motor, which is connected by means of hydraulic lines to a pressure energy source. In the case of a compact arrangement, a hydraulic motor permits a high force transmission.

According to the invention, a particularly robust, reliable control arrangement is brought about by providing controllable valves, which are controllable by means of the control device.

A measurement of the superimposed load on the cable, such as is e.g. necessary for well drilling, can be reliably and simply achieved according to the invention in that the hydraulic lines incorporate at least one pressure gauge for measuring a hydraulic pressure, the pressure gauge being connected to the control device. According to the invention the pressure in the hydraulic line is correlated with the superimposed load and can consequently be used by means of correspondingly taking account of a correlation rule in the control device for the determination, control or regulation of the desired superimposed load on the drilling equipment.

In order to increase the operational safety of the cable winch arrangement according to the invention, on the cable winch is constructed a hydraulically operable blocking brake, which is controllable by means of the control device.

The method for operating a cable winch arrangement according to the invention is characterized in that for raising and lowering a first operating mode is connected in the control device and that a second operating mode is connected in which a superimposed load is set on a cable of the winch. As a result of this method it is possible to achieve the aforementioned advantages when operating the cable winch arrangement according to the invention.

The invention is described in greater detail hereinafter relative to a preferred embodiment, which is diagrammatically shown in the attached hydraulic circuit diagram.

The cable winch arrangement according to the invention comprises a drum-shaped cable winch 22, which is mounted in rotary manner in a holder 23 and can be driven by a diagrammatically represented drive shaft using a winch drive 24. The cable winch 22 can be fixed by means of a blocking brake 25, which acts on the drive shaft. The winch drive 24 constructed as the sole hydraulic motor is connected by means of a subsequently further explained hydraulic line arrangement to at least one pressure energy source 20 in the form of a hydraulic pump.

The hydraulic line arrangement comprises a plurality of valves, which are controllable by means of a control device 21 for setting the two subsequently described operating modes.

First Operating Mode for Feed Winch

This first operating mode is e.g. used for the standard method with dry rotary drilling equipment.

The control device 21 connects the valves in the following way: valve 19 pressureless, valve 13 connection A blocked. Thus, no pressure is applied to the valves 17 and 16 (and consequently 2). The proportional flow regulating valve 9, 10 is also closed in this operating mode. Valve 14 is connected to high pressure. Thus, the pressure energy source 20 constructed as a constant pump delivers the volume flow directly via valve 19 to a not shown tank. As the second safety stage alongside the valve 17, check valve 11 prevents oil flowing out of the winch control 26 via line B′. Thus, only the normal winch mode and not the superimposed load control is active. For this purpose the pressure energy can be made available by a further, not shown pressure energy source.

On now providing pressure for “raising” or “lowering”, by means of the changeover valve in the winch control block 26 and the changeover valve 16, valve 2 is operated and therefore the blocking brake 25 is released. The blocking valve in the winch control block 26 is also opened, but only to the extent that the winch drive 24 can wind up or unwind in controlled manner the cable winch 22.

Second Operating Mode for Superimposed Load Control

This operating mode is e.g. used if the drilling equipment is used with flush or wash boring or drilling means, e.g. for well drilling.

Valve 19 is switched over, so that the pressure energy source 20 can produce high pressure. Valve 14 is switched over to low pressure. This pressure setting is higher than the feed pressure, so that via valve 14 no oil can flow out of the feed circuit. Valve 9, 10 is closed. Valve 13 can now be reversed in order to open check valve 17 and the blocking brake 25 with the aid of valve 2. Switching over of valve 13 is only released when the pressure switch 12 indicates an adequately high pressure.

After releasing the blocking brake 25, the cable winch 22 is wound up at low speed, because the volume flow is supplied by the pressure energy source 20. The pressure gauge 8 can now detect the pressure necessary for raising the suspended flush drilling line. In order to calculate the load on the winch (in this state corresponds to the drilling line weight) by means of the pressure, account must be taken of the initial load produced by the valve 14.

The control now slowly opens valve 9, 10, so that the volume flow can flow out. If a greater volume flow flows out than is delivered by the pump 20, the cable winch 22 starts to unwind. Thus, in this operating mode it is possible to have a cable unwinding from the cable winch 22 with a predetermined superimposed load and with the same winch drive 24 as can be used in normal winch operation.

When the drilling line is lowered to the bottom, the superimposed load on the drill head rises. The control ensures that the set superimposed load is not exceeded.

Through the continuous pressure measurement at gauge 8, in the case of falling pressure and therefore excessive superimposed load, the control can somewhat close the flow regulating valve 9, 10 in order to once again obtain the predetermined superimposed load. With rising pressure at the pressure gauge 8 and therefore inadequate superimposed load, the flow regulating valve 9, 10 is correspondingly opened by the control device 21.

Thus, if the superimposed load is excessive, the inventive control does not lower the drilling line as rapidly as the drilling progress or advance, or may even raise the same. If the detected superimposed load is inadequate, the drilling line is once again more rapidly lowered by the cable winch 22, so that it is more strongly supported on the bottom.

At the end of drilling, there is a switch once again into the first operating mode for drawing out the drilling line.

1. Cable winch arrangement with a cable winch, a winch drive and a control device, wherein by the control device it is possible to set a first operating mode for raising and lowering and a second operating mode in which a superimposed load can be set on a cable of the cable winch.

2. Cable winch arrangement according to claim 1, wherein the winch drive has a hydraulic motor connected by means of hydraulic lines to at least one pressure energy source.

3. Cable winch arrangement according to claim 1, wherein controllable valves are provided and are controllable by means of the control device.

4. Cable winch arrangement according to claim 2, wherein at least one pressure gauge for measuring a hydraulic pressure is provided in the hydraulic lines, the pressure gauge being connected to the control device.

5. Cable winch arrangement according to claim 1, wherein a hydraulically operable blocking brake is provided on the cable winch and is controllable by means of the control device.

6. Method for operating a cable winch arrangement with a cable winch, a winch drive and a control device, wherein for raising and lowering, a first operating mode is connected in the control device and that a second operating mode is connected in order to set a superimposed load on a cable of the cable winch.

7. Method according to claim 6, wherein the cable winch is driven by a hydraulic motor connected by means of hydraulic lines to a pressure energy source.

8. Method according to claim 7, wherein valves are provided for controlling the hydraulic motor and are controlled by means of the control device.

9. Method according to claim 7, wherein a hydraulic pressure is measured by means of at least one pressure gauge in the hydraulic lines and that the values determined by the pressure gauge are transmitted on to the control device.

10. Method according to claim 6, wherein a blocking brake is provided for braking and fixing the cable winch and it is controlled by means of the control device.
